(19) United States
(12) Patent Application Publication
(10) Pub. No.: US 2014/0033267 A1
(43) Pub. Date: Jan. 30, 2014

(54) TYPE MINING FRAMEWORK FOR AUTOMATED SECURITY POLICY GENERATION

(71) Applicant: Samsung Electronics Co., Ltd., Suwon (KR)

(72) Inventor: Onur Aciicmez, San Jose, CA (US)

(73) Assignee: SAMSUNG ELECTRONICS CO., LTD., Suwon (KR)

(21) Appl. No.: 13/952,445

(22) Filed: Jul. 26, 2013

Related U.S. Application Data
(60) Provisional application No. 61/676,302, filed on Jul. 26, 2012.

(51) Int. Cl. H04L 29/06

(52) U.S. Cl. CPC H04L 63/20
USPC 726/1

(57) ABSTRACT

One embodiment provides an automated security policy generation system for a computing system including at least one resource and at least one subject. The automated security policy generation system comprises a clustering module configured for clustering the subjects and the resources into at least one subject cluster and at least one resource cluster, respectively, based on one or more access permissions. Each access permission represents a permission that a subject requires to access a resource. The automated security policy generation system further comprises a recommendation module configured for generating a security recommendation for the computing system based the subject clusters and the resource clusters. Access to the resources by the subjects is controlled based on the security recommendation.

### CROSS-REFERENCE TO RELATED APPLICATIONS

This application claims priority to United States (U.S.) Provisional Patent Application Ser. No. 61/676,302, filed on Jul. 26, 2012, which is incorporated herein by reference.

### TECHNICAL FIELD

One or more embodiments relate generally to security and access control policy for computing systems, and in particular, automated security policy generation for a computing system.

### BACKGROUND

Computer security is information security as applied to computers and networks. In computer security, access control is the selective restriction of access to a resource of a computing system. Mandatory access control (MAC) refers to a type of access control by which an operating system of a computing system constrains the ability of a subject (e.g., a process or thread) of the computing system to access an object (e.g., a file, a directory) of the computing system.

### SUMMARY

One embodiment provides an automated security policy generation system for generating a security recommendation for a computing system including at least one resource and at least one subject. The automated security policy generation system comprises a clustering module configured for clustering the subjects and the resources into at least one subject cluster and at least one resource cluster, respectively, based on one or more access permissions. Each access permission represents a permission that a subject requires to access a resource. The automated security policy generation system further comprises a recommendation module configured for generating a security recommendation for the computing system based on the subject clusters and the resource clusters. Access to the resources by the subjects is controlled based on the security recommendation.

One embodiment provides an automated security policy generation system for generating a security recommendation for facilitating label-based access control in a computing system including at least one resource and at least one subject. The automated security policy generation system comprises a labeling module configured for generating a corresponding security label for each subject and each resource based on one or more access permissions. Each access permission represents a permission that a subject requires to access a resource. The automated security policy generation system further comprises a recommendation module configured for generating, based on the security labels generated, a security recommendation for facilitating label-based access control in the computing system. Access to the resources by the subjects is controlled based on the security recommendation.

One embodiment provides a method for generating a security recommendation for a computing system including at least one resource and at least one subject. The method comprises a clustering module configured for clustering the subjects and the resources into at least one subject cluster and at least one resource cluster, respectively, based on one or more access permissions. Each access permission represents a permission that a subject requires to access a resource. The method further comprises a recommendation module configured for generating a security recommendation for the computing system based on the subject clusters and the resource clusters. Access to the resources by the subjects is controlled based on the security recommendation.

One embodiment provides a method for generating a security recommendation for facilitating label-based access control in a computing system including at least one resource and at least one subject. The method comprises a labeling module configured for generating a corresponding security label for each subject and each resource based on one or more access permissions. Each access permission represents a permission that a subject requires to access a resource. The method further comprises a recommendation module configured for generating, based on the security labels generated, a security recommendation for facilitating label-based access control in the computing system. Access to the resources by the subjects is controlled based on the security recommendation.

One embodiment provides a non-transitory computer-readable medium having instructions which when executed on a computer perform a method for generating a security recommendation for a computing system including at least one resource and at least one subject. The method comprises a clustering module configured for clustering the subjects and the resources into at least one subject cluster and at least one resource cluster, respectively, based on one or more access permissions. Each access permission represents a permission that a subject requires to access a resource. The method further comprises a recommendation module configured for generating a security recommendation for the computing system based on the subject clusters and the resource clusters. Access to the resources by the subjects is controlled based on the security recommendation.

One embodiment provides a non-transitory computer-readable medium having instructions which when executed on a computer perform a method for generating a security recommendation for facilitating label-based access control in a computing system including at least one resource and at least one subject. The method comprises a labeling module configured for generating a corresponding security label for each subject and each resource based on one or more access permissions. Each access permission represents a permission that a subject requires to access a resource. The method further comprises a recommendation module configured for generating, based on the security labels generated, a security recommendation for facilitating label-based access control in the computing system. Access to the resources by the subjects is controlled based on the security recommendation.

These and other aspects and advantages of one or more embodiments will become apparent from the following detailed description, which, when taken in conjunction with the drawings, illustrate by way of example the principles of one or more embodiments.

### BRIEF DESCRIPTION OF THE DRAWINGS

For a fuller understanding of the nature and advantages of one or more embodiments, as well as a preferred mode of use, reference should be made to the following detailed description read in conjunction with the accompanying drawings, in which:

FIG. 1 shows a block diagram of a computing system, in accordance with an embodiment.

FIG. 2 shows a block diagram of an automated security policy generation system for the computing system in FIG. 1, in accordance with an embodiment.

FIG. 3 illustrates a block diagram of a monitoring and analysis module, in accordance with an embodiment.

FIG. 4 illustrates an example access requirements graph, in accordance with an embodiment.

FIG. 5 illustrates an example access matrix for the access requirements graph in FIG. 4, in accordance with an embodiment.

FIG. 6 shows a block diagram of an example policy generation module, in accordance with an embodiment.

FIG. 7 illustrates an example object-permissions-access (OPA) matrix for the access graph in FIG. 4, in accordance with an embodiment.

FIG. 8 illustrates an example subject-permissions-access (SPA) matrix for the access graph in FIG. 4, in accordance with an embodiment.

FIG. 9 illustrates clustering of an example access restrictions graph, in accordance with an embodiment.

FIG. 10 illustrates an example flow chart for automating security policy generation for a computing system, in accordance with an embodiment.

FIG. 11 illustrates an example flow chart for generating type enforcement configuration and policy rules for a computing system based on an access requirements graph for the computing system, in accordance with an embodiment.

FIG. 12 is a high-level block diagram showing an information processing system comprising a computing system implementing an embodiment.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One embodiment provides an automated security policy generation system for generating a security recommendation for a computing system including at least one resource and at least one subject. The automated security policy generation system comprises a clustering module configured for clustering the subjects and the resources into at least one subject cluster and at least one resource cluster, respectively, based on one or more access permissions. Each access permission represents a permission that a subject requires to access a resource. The automated security policy generation system further comprises a recommendation module configured for generating a security recommendation for the computing system based on the subject clusters and the resource clusters. Access to the resources by the subjects is controlled based on the security recommendation.

One embodiment provides an automated security policy generation system for generating a security recommendation for facilitating label-based access control in a computing system including at least one resource and at least one subject. The automated security policy generation system comprises a labeling module configured for generating a corresponding security label for each subject and each resource based on one or more access permissions. Each access permission represents a permission that a subject requires to access a resource. The automated security policy generation system further comprises a recommendation module configured for generating, based on the security labels generated, a security recommendation for facilitating label-based access control in the computing system. Access to the resources by the subjects is controlled based on the security recommendation.

One embodiment provides a method for generating a security recommendation for a computing system including at least one resource and at least one subject. The method comprises a clustering module configured for clustering the subjects and the resources into at least one subject cluster and at least one resource cluster, respectively, based on one or more access permissions. Each access permission represents a permission that a subject requires to access a resource. The method further comprises a recommendation module configured for generating a security recommendation for the computing system based on the subject clusters and the resource clusters. Access to the resources by the subjects is controlled based on the security recommendation.

One embodiment provides a method for generating a security recommendation for facilitating label-based access control in a computing system including at least one resource and at least one subject. The method comprises a labeling module configured for generating a corresponding security label for each subject and each resource based on one or more access permissions. Each access permission represents a permission that a subject requires to access a resource. The method further comprises a recommendation module configured for generating, based on the security labels generated, a security recommendation for facilitating label-based access control in the computing system. Access to the resources by the subjects is controlled based on the security recommendation.

One embodiment provides a non-transitory computer-readable medium having instructions which when executed on a computer perform a method for generating a security recommendation for a computing system including at least one resource and at least one subject. The method comprises a clustering module configured for clustering the subjects and the resources into at least one subject cluster and at least one resource cluster, respectively, based on one or more access permissions. Each access permission represents a permission that a subject requires to access a resource. The method further comprises a recommendation module configured for generating a security recommendation for the computing system based on the subject clusters and the resource clusters. Access to the resources by the subjects is controlled based on the security recommendation.

One embodiment provides a non-transitory computer-readable medium having instructions which when executed on a computer perform a method for generating a security recommendation for facilitating label-based access control in a computing system including at least one resource and at least one subject. The method comprises a labeling module configured for generating a corresponding security label for each subject and each resource based on one or more access permissions. Each access permission represents a permission that a subject requires to access a resource. The method further comprises a recommendation module configured for generating, based on the security labels generated, a security recommendation for facilitating label-based access control in the computing system. Access to the resources by the subjects is controlled based on the security recommendation.

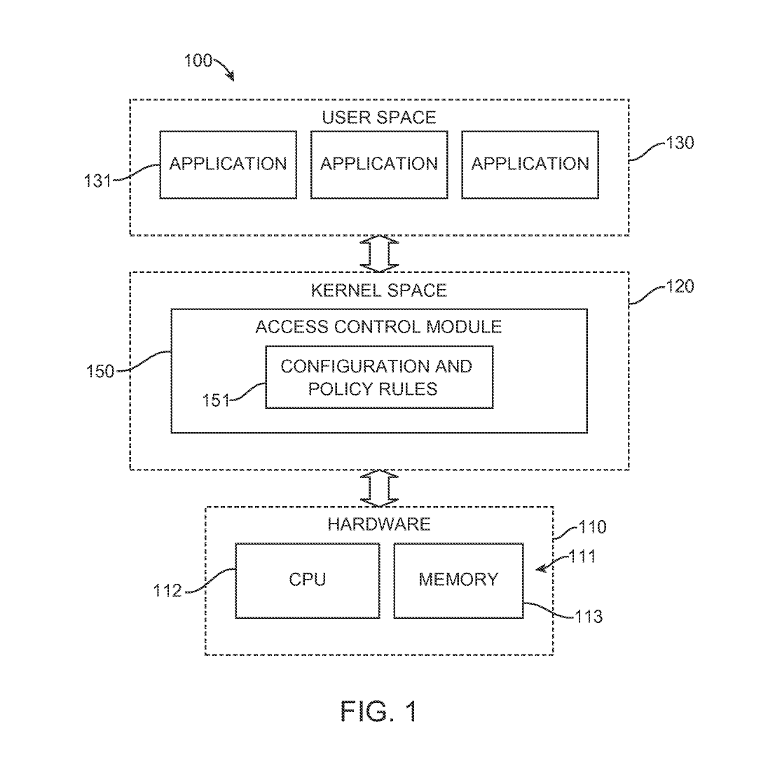

FIG. 1 shows a block diagram of a computing system 100, in accordance with an embodiment. The computing system 100 comprises hardware architecture 110, a kernel space 120, and a user space 130.

The hardware architecture 110 includes one or more hardware resources 111, such as a central processing unit (CPU) 112 and a memory unit 113.

A process is an executing (i.e., running instance) of an application program 131. One or more processes of one or more application programs 131 run within the user space 130.

The kernel space 120 executes an operating system kernel that provides services for managing the hardware resources 111 and facilitating how the application programs 131 run and utilize the hardware resources 111. The kernel functions as an intermediary between the application programs 131 and the hardware resources 111.

In one embodiment, the kernel includes an access control module 150 for implementing computing security in the computing system 100. For example, the access control module 150 may implement mandatory access control (MAC). MAC is a type of access control by which a computing system constrains the ability of a subject or initiator to access or perform an operation (e.g., read, write, execute, append, etc.) on an object or target. A subject is an active entity (e.g., a process or thread of an application program 131) in a computing system that performs an access. An object is a passive entity (e.g., files or directories maintained in a hardware resource 111) in a computing system. An access attempt occurs when a subject of a computing system attempts to perform an operation on an object of the computing system.

In one embodiment, the access control module 150 maintains security policy information 151 including access control configuration data and one or more security policy rules. The access control module 150 controls access rights of subjects on objects based on the security policy information 151 maintained.

Type enforcement (TE) is an example MAC model. In type enforcement, each subject and each object is associated with a corresponding type. In this specification, a type is a security label used to identify an entity. In one embodiment, the security policy information 151 maintained is a label-based type enforcement security policy. For example, the security policy information 151 maintained may indicate which types of objects each type of subject may access and perform operations (e.g., read, write, execute, append) on. When a subject makes an access attempt on an object, the access control module 150 determines whether to allow or deny the access attempt based on the type of the object, the type of the subject, and the security policy information 151 maintained.

In one embodiment, the computing system 100 is an electronic device, such as a mobile phone (e.g., a smart phone), a tablet, a computer, a laptop, etc.

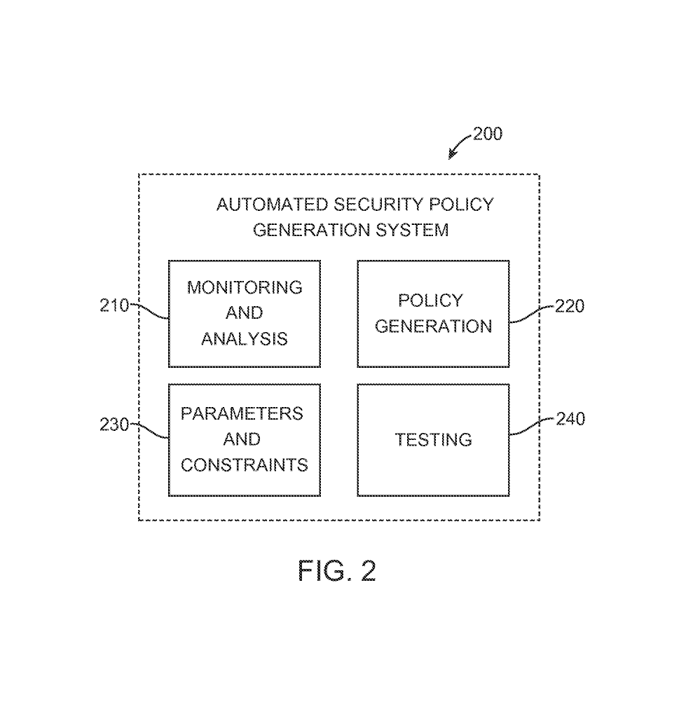

FIG. 2 shows a block diagram of an automated security policy generation system 200 for the computing system 100 in FIG. 1, in accordance with an embodiment. The automated security policy generation system 200 generates a security recommendation for the computing system 100. The security recommendation comprises recommended security policy information 151 including recommended access control configuration data and one or more recommended security policy rules. The access control module 150 may control access to hardware resources 111 of the computing system 100 based on the recommended security policy information 151.

In one embodiment, the recommended security policy information 151 generated is a label-based type enforcement security policy.

In one embodiment, the automated security policy generation system 200 comprises a monitoring and analysis module 210, a policy generation module 220, a parameters and constraints module 230, and a testing module 240.

As described in detail later herein, the monitoring and analysis module 210 includes dynamic analysis and monitoring tools for gathering security and access control requirements of the computing system 100. An access control requirement defines which subject (e.g., an application program 131) requires access to an object (e.g., a hardware resource 111), and the type of access required. The monitoring and analysis module 210 generates an access requirements graph 400 based on the information gathered.

The policy generation module 220 processes the access requirements graph 400 and applies data mining algorithms and techniques to generate recommended security policy information 151 for the computing system 100.

The parameters and constraints module 230 maintains pre-determined access control parameters and constraints. The policy generation module 220 may optimize the recommended security policy information 151 based on the access control parameters and constraints maintained.

The testing module 240 maintains one or more test routines for testing the recommended security policy information 151. The testing module 240 utilizes the test routines to validate the recommended security policy information 151 and measure performance of the computing system 100. If testing results indicate that a revision to the recommended security policy information 151 is necessary (e.g., a performance constraint is not met or an access control requirement needs to be relaxed or tightened because of an update to the computing system 100), the automated security policy generation system 200 will revise the recommended security policy information 151 using the monitoring and analysis module 210 and/or the policy generation module 220. Therefore, the process of generating recommended security policy information 151 may be iterative.

In one embodiment, the automated security policy generation system 200 resides in the user space 130 of the computing system 100. In another embodiment, the automated security policy generation system 200 resides in the kernel space 120 of the computing system 100. In yet another embodiment, one or more components of the automated security policy generation system 200 resides in the user space 130 of the computing system 100, while the remaining components of the automated security policy generation system 200 resides in the kernel space 230 of the computing system 100.

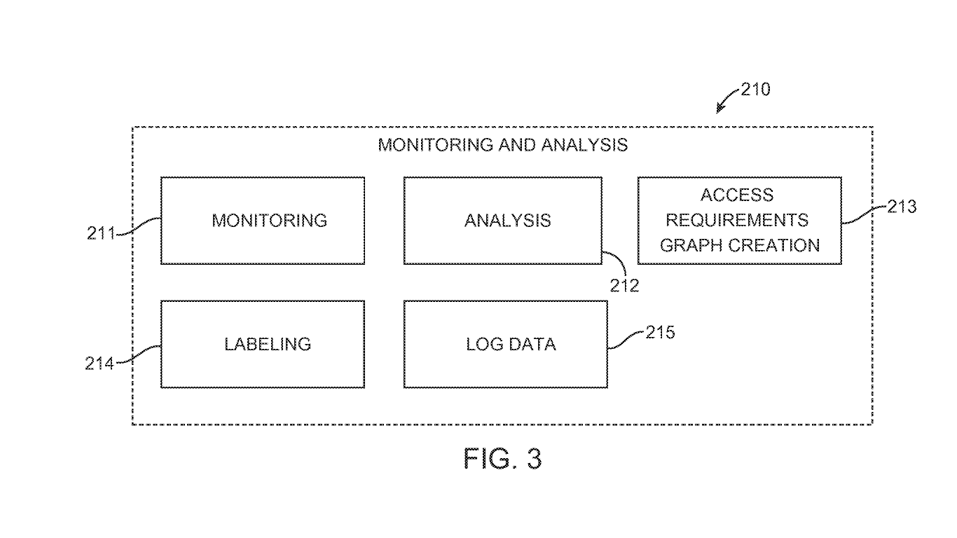

FIG. 3 illustrates a block diagram of a monitoring and analysis module 210, in accordance with an embodiment. The monitoring and analysis module 210 dynamically monitors and analyzes the computing system 100 to determine security and access control requirements of the computing system 100.

The monitoring and analysis module 210 comprises a monitoring module 211, an analysis module 212, an access requirements graph creation module 213, a labeling module 214, and a memory module 215.

The monitoring module 211 monitors the computing system 100 by capturing and recording each time a subject of the computing system 100 accesses an object of the computing system 100, and with what access permissions. For example, the monitoring module 211 captures and records system traces like system calls, access attempts, etc. The information captured and recorded by the monitoring module 211 may be maintained in the memory module 215 in the form of log data. The labeling module 214 may be used to generate a unique label for each object of the computing system 100, thereby facilitating the logging of every access/access attempt in the computing system 100.

The analysis module 212 extracts/derives security and access control requirements for the computing system 100 from the information captured and recorded by the monitoring module 211. The access requirements graph creation module 213 creates an access requirements graph 400 based on the security and access control requirements extracted.

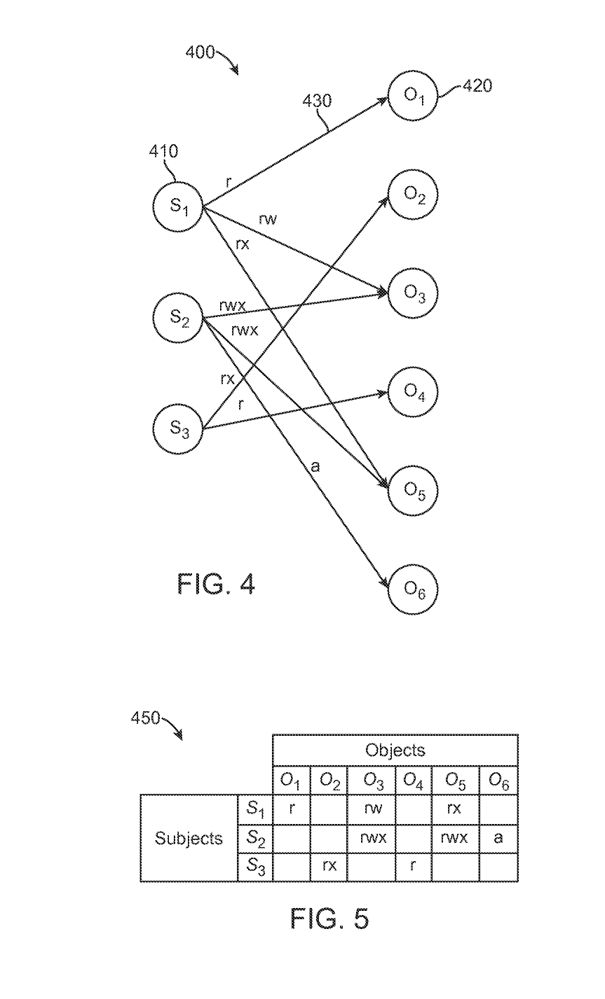

FIG. 4 illustrates an example access requirements graph 400, in accordance with an embodiment. An access requirements graph 400 represents all security and access control requirements within a computing system 100.

As shown in FIG. 4, the graph 400 comprises multiple nodes, including at least one subject node (“subject”) 410 representing a subject of the computing system 100, and at least one object node (“object”) 420 representing an object of the computing system 100. For example, as shown in FIG. 4, the graph 400 comprises subjects S₁, S₂ and S₃, and objects O₁, O₂, O₃, O₄, O₅, and O₆.

The graph 400 further comprises at least one edge 430. An access between a subject 410 and an object 420 is represented as an edge 430 from the subject 410 to the object 420.

In one embodiment, the graph 400 may be represented using equation (1) provided below:

A=(S,O,P) (1),

wherein S denotes a set of subjects 410 of the graph 400, wherein O denotes a set of objects 420 of the graph 400, and wherein P denotes a set of edges 430 of the graph 400.

The set of edges P may be represented using the equation (2) provided below:

P={(subj,obj)|subjεS [symbol] objεO [symbol] subj [symbol] obj} (2),

wherein subj [symbol] obj denotes that subject subj needs access to object obj in order for the computing system 100 to function properly.

Each edge 430 has a corresponding access type representing an access permission. In one embodiment, the available access types include read (r), write (w), execute (x), and append (a).

The graph 400 may also be represented using equation (3) provided below:

A=(S,O,P,AT) (3),

wherein AT denotes a set of access types of the graph 400.

The set of edges P may also be represented using the equation (4) provided below:

P={(subj,obj,at)|subjεS [symbol] objεO [symbol] atεAT [symbol] subj [symbol] (obj,at)} (4)

wherein subj [symbol] (obj,at) denotes that subject subj needs access type at to access object obj in order for the computing system 100 to function properly.

For the graph 400 shown in FIG. 4, S={S₁, S₂, S₃}, O={O₁, O₂, O₃, O₄, O₅, O₆}, AT={r, w, x, a}, and P={(S₁, O₁, r), (S₁, O₃, r), (S₁, O₃, w), (S₂, O₅, r), (S₂, O₃, w), (S₂, O₃, x), (S₂, O₅, r), (S₂, O₅, w), (S₂, O₅, x), (S₂, O₆, a), (S₃, O₂, r), (S₃, O₂, x), (S₃, O₄, r)}. Therefore, graph 400 has 3 different subjects 410, 6 different objects 420, and 4 different access types.

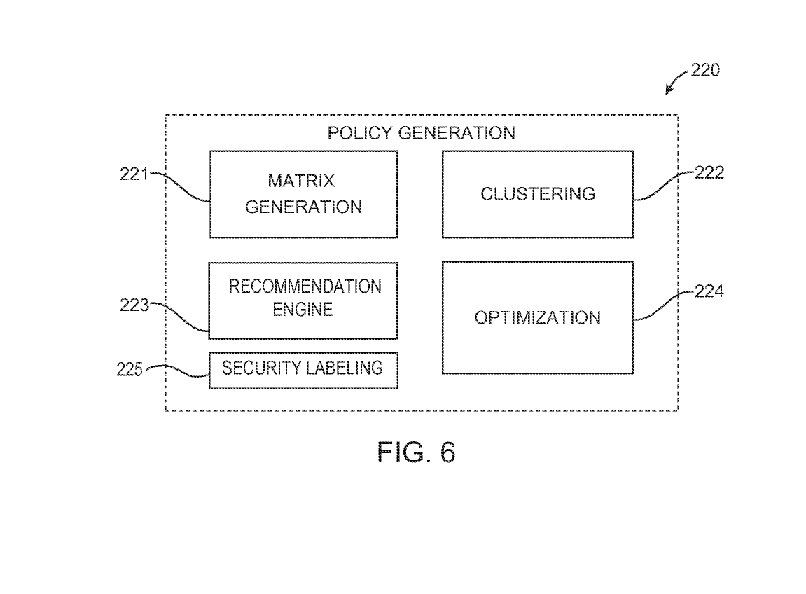

FIG. 5 illustrates an example access matrix 450 for the access requirements graph 400 in FIG. 4, in accordance with an embodiment. Each entry of the access matrix 450 denotes one or more access permissions that a subject 410 has on an object 420. For example, as shown in FIG. 5, the subject S₁ has read access and execute access on the object O₅.

FIG. 6 shows a block diagram of an example policy generation module 220, in accordance with an embodiment. The policy generation module 220 processes the access requirements graph 400 generated by the monitoring and analysis module 210, and applies data mining algorithms and techniques to generate a security recommendation for the computing system 100.

The policy generation module 220 comprises a matrix generation module 221, a clustering module 222, a recommendation engine module 223, an optimization module 224, and a security labeling module 225.

Let s=|S|, wherein s denotes the number of subjects included in the set S. Let r=|O|, wherein r denotes the number of objects included in the set O. Let d=|AT|, wherein d denotes the number of access types included in the set AT. For example, for the graph 400 in FIG. 4, s=3, r=6, and d=4.

The matrix generation module 221 generates two matrices based on the graph 400: (1) an object-permission-association (OPA) matrix 460, and (2) a subject-permission-association (SPA) matrix 470.

The OPA matrix 460 is an r by s*d binary/Boolean matrix, wherein an entry p_{i,(j*k)} of the OPA matrix 460 is equal to 1 if there is an edge 430 of access type k from Sⱼ to Oᵢ in the graph 400. The SPA matrix 470 is an s by r*d binary/Boolean matrix, wherein an entry p_{i,(j*k)} of the SPA matrix 470 is equal to 1 if there is an edge 430 of access type k from Sⱼ to Oᵢ in the graph 400.

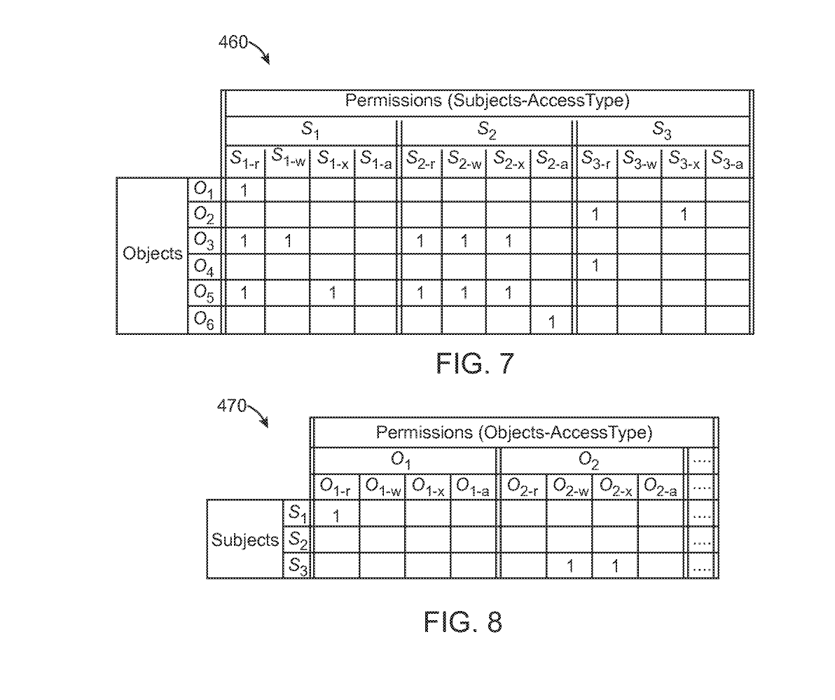

As s=3, r=6, and d=4 for the graph 400 in FIG. 4, the corresponding OPA matrix 460 is a 6 by 12 binary matrix (as shown in FIG. 7), and the corresponding SPA matrix 470 is a 3 by 24 binary matrix (a section of which is shown in FIG. 8).

In type enforcement, each subject 410 is assigned to a domain, and each object 420 is assigned a type. The associations between subjects and domains, objects and types, and the security policy information 151 that control the access rights constitute type enforcement configuration.

In this specification, type-mining is defined as the process of grouping subjects 410 into a set of domains, grouping objects into a set of types, and identifying associations between domains and types. Let D denote a domain set, wherein each element in the domain set D is a set of subjects 410. Let T denote a type set, wherein each element in type set T is a set of objects 420.

In one embodiment, type-mining is implemented using clustering. For example, the clustering module 222 applies a clustering algorithm to the OPA matrix 460 and the SPA matrix 470 to determine object clusters (i.e., resource clusters) 520 and subject clusters 510, respectively. Specifically, the clustering module 122 considers each row of the OPA matrix 460 and the SPA matrix 470 as a vector, and groups the vectors into different clusters using the clustering algorithm.

Clustering objects 420 facilitates the finding of groups of objects 420 that have similar access type and permission characteristics. Objects 420 within the same object cluster 520 are assigned the same type (type label). Similarly, clustering subjects 410 facilitates the finding of groups of subjects 410 that have similar access type and permission characteristics. Subjects 410 within the same subject cluster 510 are be assigned the same domain (domain label).

In another embodiment, type-mining is implemented by applying non-clustering data mining algorithms and techniques to the OPA matrix 460 and the SPA matrix 470.

The security labeling module 225 generates security labels for each subject 410 and each object 420. Specifically, the security labeling module 225 associates each subject 410 with a corresponding domain label, and associates each object 420 with a corresponding type label.

The recommendation engine module 223 generates a security recommendation for the computing system 100. The security recommendation generated comprises recommended security policy information 151 including access control configuration data and security policy rules. In one embodiment, the security policy information 151 is a label-based type enforcement security policy.

The optimization module 224 may optimize the security recommendation generated based on the access control parameters and constraints maintained.

Let C denote a Boolean matrix resulting from a Boolean matrix operation ⊚ between two Boolean matrices. In one embodiment, the Boolean matrix C may be expressed using the equation (5) provided below:

C=A⊚B (5),

wherein A is a k by l*d Boolean matrix, wherein B is l by m Boolean matrix, and wherein C is a k by m*d Boolean matrix. Each entry C_{i,j} of the matrix C is represented by equation (6) provided below:

$${c}_{i , j} = {{V}_{t = 1}}^{i} ( {a}_{i , ( t - 1 ) \cdot d + rem ( \text{?} j - 1 , d ) + 1} ⋀ {b}_{t , \text{?} \frac{j}{d} \text{?}} ) , \\ \text{?} \text{indicates text missing or illegible when filed} \qquad ( 6 ) ,$$

wherein 1≦i≦k, wherein 1≦j≦m, wherein rem(j−1,d) represents the remainder of j−1 divided by d, and wherein

$$⌈ \frac{j}{d} ⌉$$

is the ceiling of j divided by d.

Let DS denote a domain-to-subject assignment. Let OT denote an object-to-type assignment. Let TDP denote a type-domain-permission assignment. Let δ denote a cost metric for the object clusters and the subject clusters. The object-to-type assignment OT, the domain-to-subject assignment DS, and the type-domain-permission assignment TDP are δ-consistent to the OPA matrix 460 if the expression (7) provided below is satisfied:

∥((M(OT) [symbol] M(TDP))⊚M(DS))−M(OPA)∥₁≦δ (7),

wherein M(OT), M(TDP), M(DS) and M(OPA) denote binary matrix representations of OT, TDP, DS and the OPA matrix 460, respectively.

In one embodiment, to strictly enforce a least-privilege principle, type enforcement configuration included in a security recommendation must allow only accesses represented in the graph 400 without granting any extra privileges to the subjects 410. Let TEC denote an example type enforcement configuration included in a security recommendation for the graph 400. The type enforcement configuration TEC may be represented using the equation (8) provided below:

TEC=(T,D,OT,DS,TDP) (8).

The type enforcement configuration TEC strictly enforces the least-privilege principle if T=O, D=S, M(OT) and M(DS) are identity matrices, and M(TDP)=M(OPA). Therefore, a unique type label and a unique domain label may be assigned to each object 420 and each subject 410, respectively, thereby generating a security policy rule for each edge 430 in the graph 400. This may result in a large number of types, domains, and security policy rules, thereby adversely affecting system performance and manageability of the computing system 100.

In another embodiment, different objects 420 and different subjects 410 are grouped into types and domains, respectively, based on the similarity of their access characteristics and access control requirements. For example, two cost factors/metrics may be considered when evaluating a type enforcement configuration: (1) a performance cost representing the effect of the type enforcement configuration on overall system performance of the computing system 100, and (2) a security cost representing deviations from the least-privilege principle.

A vector function such as an L₁-metric (i.e., L₁-norm) may be used to measure deviations between the least-privilege principle and the type enforcement configuration. For example, the L₁-metric and the expression (7) for δ-consistency may be used by the policy generation module 220 to derive a cost function for evaluating a type enforcement configuration.

The security cost of a type enforcement configuration may be represented using the equation (9) provided below:

Cₛ=∥((M(OT) [symbol] M(TDP))⊚M(DS))−M(OPA)∥₁ (9),

The performance cost of a type enforcement configuration is based on the number of security policy rules included in the type enforcement configuration. The number of security policy rules, which is related to the size of TDP, affects the execution time of the computing system 100 because the access control module 150 checks the security policy rules during each access attempt to determine whether to allow or deny the access attempt. Therefore, the larger the number of security policy rules, the longer it takes in average for the access control module 150 to allow or deny an access attempt. The number of security policy rules also affects memory consumption of the computing system 100 because the security police rules are maintained in the kernel space 120. The performance cost of a type enforcement configuration may be represented using the equation (10) provided below:

Cₚ=∥M(TDP)∥₁, (10),

wherein ∥ ∥₁ denotes the pair-wise 1-norm of a binary matrix representing TDP.

An overall cost associated with a type enforcement configuration is represented by the equation (11) provided below:

Cost=αCₛ+βCₚ (11),

wherein α and β are pre-determined for meeting specific performance and security requirements of the computing system 100.

Table 1 below provides example pseudo code for implementing a clustering algorithm applied by the clustering module 222. In Table 1, the clustering algorithm is denoted as ClusteringAlgorithm.

TABLE 1

```
Function: ClusteringAlgorithm
Input: Q (OPA or SPA matrix) and k (number of clusters)
Output: C (set of clusters)
    C ← generate initial k clusters
    δ = CalculateCost(Q,C,k)
    do
        δ_{copy} = δ
        C_{copy} = C
        for each row q in Q
            c_{best} = FindBestCluster(q,P,C,k)
            update C by assigning q into c_{best}
        end for
        δ = CalculateCost(Q,C,k)
    while δ < δ_{copy}
    return C
Function: FindBestCluster
Input: q (row in OPA or SPA matrix), Q (OPA or SPA matrix),
C (set of clusters) and k (number of clusters in C)
Output: c_{best} (index of a cluster)
    δ_{best} = CalculateCost(Q,C,k)
    for i from 1 to k
        c ← i^{th} cluster in C
        update C by assigning p into c
        δ = CalculateCost(Q,C,k)
        if δ < δ_{best}
            δ_{best} = δ
            c_{best} = c
        end if
    end for
    return c_{best}
Function: CalculateCost
Input: Q (OPA or SPA matrix), C (set of clusters) and k
(number of clusters in C)
Output: δ (cost metric for the clusters)
    δ ← calculate cluster cost metric using Q
    return δ
```

The clustering algorithm provides OT and DS. The type-domain-permission assignment TDP may be represented by equation (12) provided below:

M(TDP)=(M(OT)^{T} [symbol] M(OPA))⊚M(DS)^{T} (12),

wherein M(OT)^{T} and M(DS)^{T} are transposes of the binary matrix representations of OT and DS, respectively.

As stated above, in one embodiment, the automated security policy generation system 200 resides in the user space 130 of the computing system 100. In another embodiment, the automated security policy generation system 200 resides in the kernel space 120 of the computing system 100. In yet another embodiment, one or more components of the automated security policy generation system 200 resides in the user space 130 of the computing system 100, while the remaining components of the automated security policy generation system 200 resides in the user space 130 of the computing system 100. For example, the monitoring and analysis module 210, the matrix generation module 221, the clustering module 222 and the security labeling module 225 may reside in the user space 130, while the recommendation engine module 223 and the optimization module 224 may reside in the kernel space 120.

FIG. 7 illustrates an example object-permissions-access (OPA) matrix 460 for the access graph 400 in FIG. 4, in accordance with an embodiment. As stated above, the clustering module 222 considers each row of the OPA matrix 460 and the SPA matrix 470 as a vector, and groups the vectors into different clusters using the clustering algorithm.

Based on the OPA matrix 460 shown in FIG. 7, there are six vectors total for the six different objects 420, such as a first vector V_{O1}=(1,0,0,0, 0,0,0,0, 0,0,0,0) based on the first row of the OPA matrix 460 for the object O₁, a second vector V_{O2}=(0,0,0,0, 0,0,0,0, 1,0,1,0) based on the second row of the OPA matrix 460 for the object O₂, a third vector V_{O3}=(1,1,0,0, 1,1,1,0, 0,0,0,0) based on the third row of the OPA matrix 460 for the object O₃, and so on.

As shown in FIG. 7, the rows corresponding to the objects O₃ and O₅ are relatively similar. As such, the objects O₃ and O₅ may be grouped together into the same cluster and assign the same type

FIG. 8 illustrates an example subject-permissions-access (SPA) matrix 470 for the access graph 400 in FIG. 4, in accordance with an embodiment.

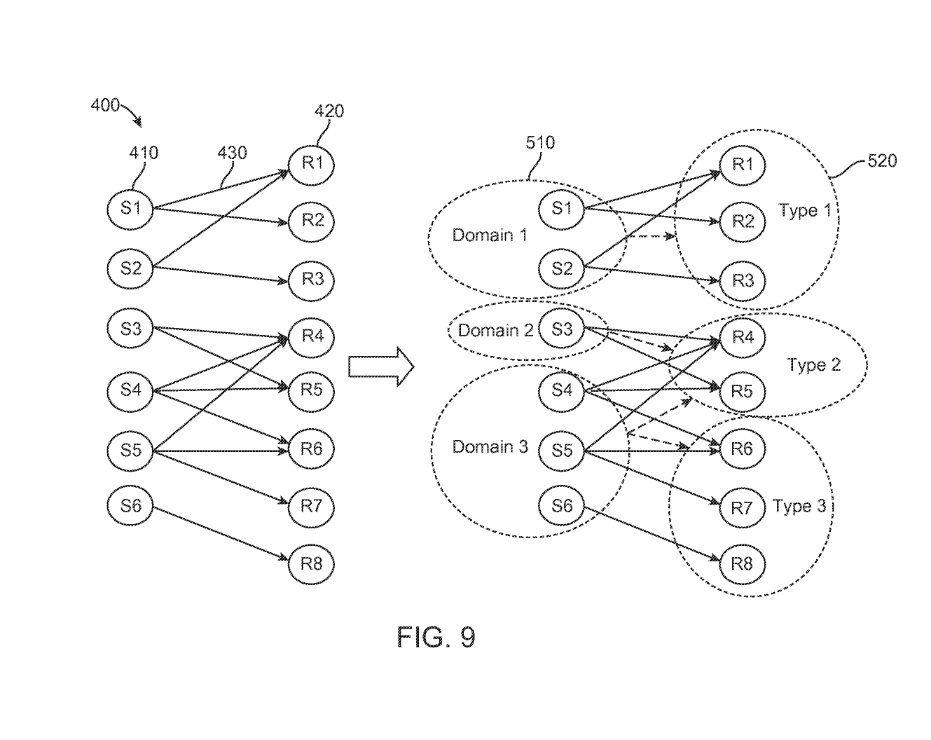

FIG. 9 illustrates clustering of an example access restrictions graph 400, in accordance with an embodiment. The policy generation module 220 clusters objects 420 and subjects 410 of the graph 400 into object clusters 520 and subjects clusters 510, respectively. Objects 420 within the same object cluster 520 are assigned the same type label. Subjects 410 within the same subject cluster 510 are be assigned the same domain label.

The type enforcement configuration and policy rules generated by the policy generation module 220 are based on the object clusters 520 and subject clusters 510. For example, the policy rules will permit access by subjects 410 assigned to domain label “Domain 1” to objects 420 assigned to type label “Type 1”.

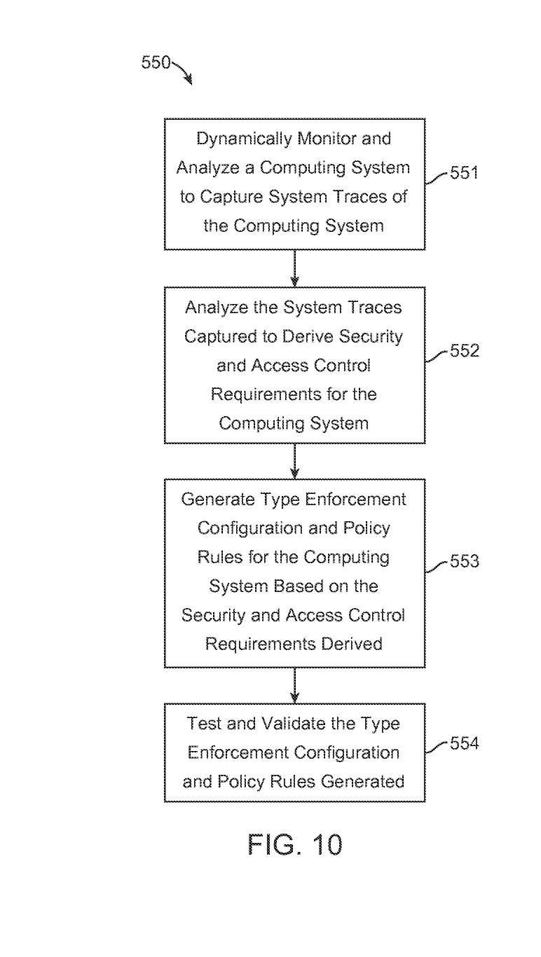

FIG. 10 illustrates an example flow chart 550 for automating security policy generation for a computing system, in accordance with an embodiment. In process block 551, dynamically monitor and analyze a computing system to capture system traces of the computing system. In process block 552, analyze the system traces captured to derive security and access control requirements for the computing system. In process block 553, generate type enforcement configuration and policy rules for the computing system based on the security and access control requirements derived. In process block 554, test and validate the type enforcement configuration and policy rules generated.

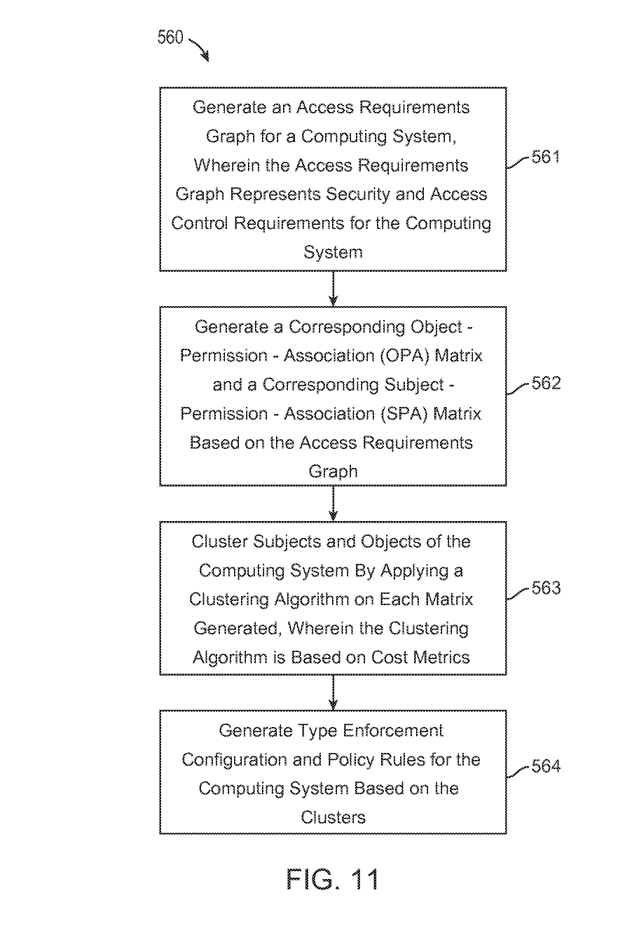

FIG. 11 illustrates an example flow chart 560 for generating type enforcement configuration and policy rules for a computing system based on an access requirements graph for the computing system, in accordance with an embodiment. In process block 561, generate an access requirements graph for a computing system, wherein the access requirements graphs represents security and access control requirements for the computing system. In process block 562, generate a corresponding object-permission-association (OPA) matrix and a corresponding subject-permission-association (SPA) matrix based on the access requirements graph. In process block 563, cluster subjects and objects of the computing system by applying a clustering algorithm on each matrix generated, wherein the clustering algorithm is based on cost metrics. In process block 564, generate type enforcement configuration and policy rules for the computing system based on the clusters.

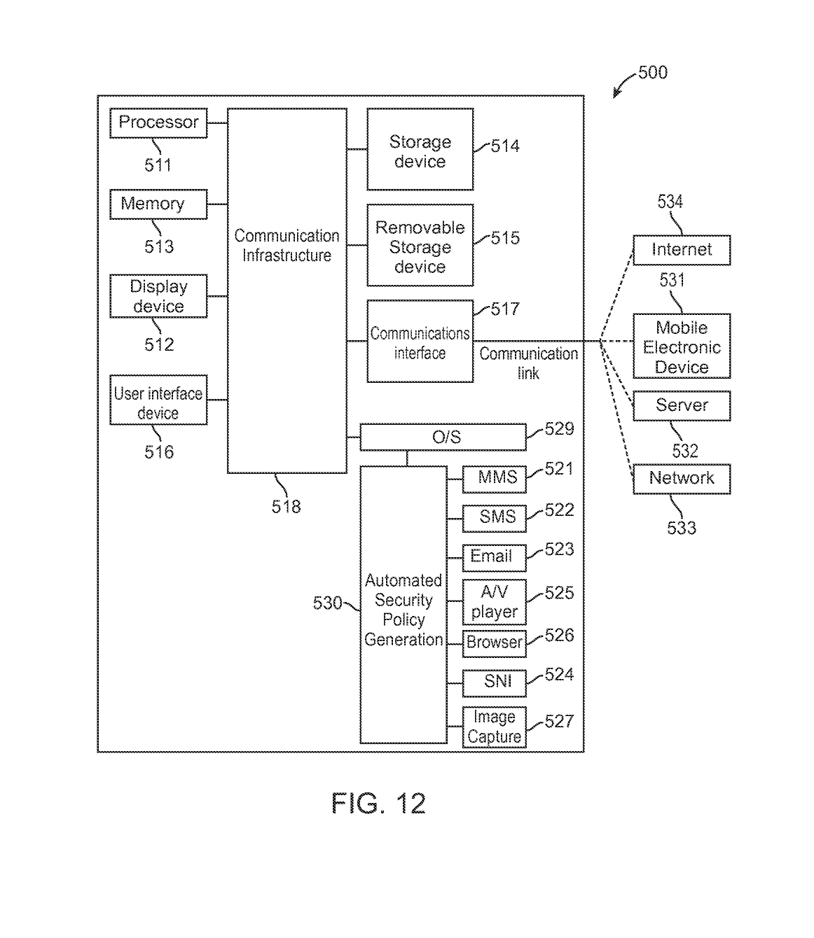

FIG. 12 is a high-level block diagram showing an information processing system comprising a computing system 500 implementing an embodiment. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card). The communication interface 517 allows software and data to be transferred between the computer system and external devices and/or networks, such as the Internet 534, a mobile electronic device 531, a server 532, and a network 533. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

The system 500 may further include application modules as MMS module 521, SMS module 522, email module 523, social network interface (SNI) module 524, audio/video (AV) player 525, web browser 526, image capture module 527, etc.

The system 500 further includes an automated security policy generation system 530 as described herein, according to an embodiment. In one embodiment, the automated security policy generation system 530 along with an operating system 529 may be implemented as executable code residing in a memory of the system 500. In another embodiment, the automated security policy generation system 530 along with the operating system 529 may be implemented in firmware.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the one or more embodiments have been described with reference to certain versions thereof; however, other versions are possible. Therefore, the spirit and scope of the appended claims should not be limited to the description of the preferred versions contained herein.

What is claimed is:

1. An automated security policy generation system for a computing system including at least one resource and at least one subject, comprising:
a clustering module configured for:
clustering said at least one subject into at least one subject cluster based on one or more access permissions, wherein each access permission represents a permission that one of said at least one subject requires to access one of said least one resource; and
clustering said at least one resource into at least one resource cluster based on said one or more access permissions; and
a recommendation module configured for:
generating a security recommendation for said computing system based on said at least one subject cluster and said at least one resource cluster, wherein access to said at least one resource by said at least one subject is controlled based on said security recommendation.

2. The automated security policy generation system of claim 1, wherein said security recommendation comprises a security policy including access control configuration data and at least one security policy rule.

3. The automated security policy generation system of claim 2, further comprising:
a monitoring and analysis module configured for:
dynamically monitoring one or more accesses to said at least one resource by said at least one subject; and
obtaining said one or more access permissions based on said one or more accesses.

4. The automated security policy generation system of claim 3, wherein dynamically monitoring one or more accesses to said at least one resource by said at least one subject comprises:
dynamically monitoring one or more system traces of said computing system, wherein said one or more system traces include at least one access attempt by one of said at least one subject on one of said at least one resource.

5. The automated security policy generation system of claim 4, wherein the monitoring and analysis module is further configured for:
generating an access requirements graph for said computing system, wherein said access requirements graph represents said one or more access permissions.

6. The automated security policy generation system of claim 5, further comprising:
a matrix generation module configured for:
generating a first matrix representing one or more access type permissions for said at least one resource based on said access requirements graph, wherein said at least one resource is clustered into said at least one resource cluster based on said first matrix; and
generating a second matrix representing one or more access type permissions for said at least one subject based on said access requirements graph, wherein said at least one subject is clustered into said at least one subject cluster based on said second matrix.

7. The automated security policy generation system of claim 6, wherein:
said at least one resource and said at least one subject is clustered using a clustering algorithm that factors one or more cost metrics associated with said computing system.

8. The automated security policy generation system of claim 1, further comprising:
a testing module configured for:
testing and validating said security recommendation based on one or more pre-determined constraints and one or more test routines.

9. An automated security policy generation system for a computing system including at least one resource and at least one subject, comprising:
a labeling module configured for:
generating a corresponding security label for each of said at least one subject and each of said at least one resource based on one or more access permissions, wherein each access permission represents a permission that one of said at least one subject requires to access one of said least one resource; and
a recommendation module configured for:
based on the security labels generated, generating a security recommendation for facilitating label-based access control in said computing system, wherein access to said at least one resource by said at least one subject is controlled based on said security recommendation.

10. The automated security policy generation system of claim 9, wherein said security recommendation comprises a security policy including access control configuration data and at least one security policy rule.

11. The automated security policy generation system of claim 10, wherein said security policy is a label-based type enforcement security policy.

12. The automated security policy generation system of claim 11, further comprising:
a monitoring and analysis module configured for:
dynamically monitoring one or more accesses to said at least one resource by said at least one subject; and
obtaining said one or more access permissions based on said one or more accesses.

13. The automated security policy generation system of claim 12, wherein dynamically monitoring one or more accesses to said at least one resource by said at least one subject comprises:
dynamically monitoring one or more system traces of said computing system, wherein said one or more system traces include at least one access attempt by one of said at least one subject on one of said at least one resource.

14. The automated security policy generation system of claim 13, wherein the monitoring and analysis module is further configured for:
generating an access requirements graph for said computing system, wherein said access requirements graph represents said one or more access permissions.

15. The automated security policy generation system of claim 14, further comprising:
a matrix generation module configured for:
generating a first matrix representing one or more access type permissions for said at least one resource based on said access requirements graph, wherein said at least one resource is clustered into said at least one resource cluster based on said first matrix; and
generating a second matrix representing one or more access type permissions for said at least one subject based on said access requirements graph, wherein said at least one subject is clustered into said at least one subject cluster based on said second matrix.

16. The automated security policy generation system of claim 15, wherein generating a corresponding security label for each of said at least one subject and each of said at least one resource based on one or more access permissions comprises:
associating each of said at least one subject with a corresponding domain label based on said second matrix and one or more cost metrics associated with said computing system; and
associating each of said at least one object with a corresponding type label based on said first matrix and said one or more cost metrics.

17. The automated security policy generation system of claim 9, further comprising:
a testing module configured for:
testing and validating said security recommendation based on one or more pre-determined constraints and one or more test routines.

18. A method for automatically generating a security policy for a computing system including at least one resource and at least one subject, comprising:
clustering said at least one subject into at least one subject cluster based on one or more access permissions, wherein each access permission represents a permission that one of said at least one subject requires to access one of said least one resource;
clustering said at least one resource into at least one resource cluster based on said one or more access permissions; and
generating a security recommendation for said computing system based on said at least one subject cluster and said at least one resource cluster, wherein access to said at least one resource by said at least one subject is controlled based on said security recommendation.

19. The method of claim 18, wherein said security recommendation comprises a security policy including access control configuration data and at least one security policy rule.

20. The method of claim 19, further comprising:
dynamically monitoring one or more accesses to said at least one resource by said at least one subject;
obtaining said one or more access permissions based on said one or more accesses; and
generating an access requirements graph for said computing system, wherein said access requirements graph represents said one or more access permissions.

21. The method of claim 20, further comprising:
generating a first matrix representing one or more access type permissions for said at least one resource based on said access requirements graph, wherein said at least one resource is clustered into said at least one resource cluster based on said first matrix; and
generating a second matrix representing one or more access type permissions for said at least one subject based on said access requirements graph, wherein said at least one subject is clustered into said at least one subject cluster based on said second matrix.

22. The method of claim 21, wherein:
said at least one resource and said at least one subject is clustered using a clustering algorithm that factors one or more cost metrics associated with said computing system.

23. The method of claim 18, further comprising:
testing and validating said security recommendation based on one or more pre-determined constraints and one or more test routines.

24. A method for automatically generating a security policy for a computing system including at least one resource and at least one subject, comprising:
generating a corresponding security label for each of said at least one subject and each of said at least one resource based on one or more access permissions, wherein each access permission represents a permission that one of said at least one subject requires to access one of said least one resource; and
based on the security labels generated, generating a security recommendation for facilitating label-based access control in said computing system, wherein access to said at least one resource by said at least one subject is controlled based on said security recommendation.

25. The method of claim 24, wherein said security recommendation comprises a label-based type enforcement security policy including access control configuration data and at least one security policy rule.

26. The method of claim 25, further comprising:
dynamically monitoring one or more accesses to said at least one resource by said at least one subject;
obtaining said one or more access permissions based on said one or more accesses;
generating an access requirements graph for said computing system, wherein said access requirements graph represents said one or more access permissions;
generating a first matrix representing one or more access type permissions for said at least one resource based on said access requirements graph, wherein said at least one resource is clustered into said at least one resource cluster based on said first matrix; and
generating a second matrix representing one or more access type permissions for said at least one subject based on said access requirements graph, wherein said at least one subject is clustered into said at least one subject cluster based on said second matrix.

27. The method of claim 26, wherein generating a corresponding security label for each of said at least one subject and each of said at least one resource based on one or more access permissions comprises:
associating each of said at least one subject with a corresponding domain label based on said second matrix and one or more cost metrics associated with said computing system; and
associating each of said at least one object with a corresponding type label based on said first matrix and said one or more cost metrics.

28. A non-transitory computer-readable medium having instructions which when executed on a computer perform a method comprising:
clustering said at least one subject into at least one subject cluster based on one or more access permissions, wherein each access permission represents a permission that one of said at least one subject requires to access one of said least one resource;
clustering said at least one resource into at least one resource cluster based on said one or more access permissions; and
generating a security recommendation for said computing system based on said at least one subject cluster and said at least one resource cluster, wherein access to said at least one resource by said at least one subject is controlled based on said security recommendation.

29. A non-transitory computer-readable medium having instructions which when executed on a computer perform a method comprising:
generating a corresponding security label for each of said at least one subject and each of said at least one resource based on one or more access permissions, wherein each access permission represents a permission that one of said at least one subject requires to access one of said least one resource; and
based on the security labels generated, generating a security recommendation for facilitating label-based access control in said computing system, wherein access to said at least one resource by said at least one subject is controlled based on said security recommendation.
